(19) United States
(12) Patent Application Publication
(10) Pub. No.: US 2008/0159301 A1
(43) Pub. Date: Jul. 3, 2008

(54) Enabling virtual private local area network services

(76) Inventor: Arjan " Arie" de Heer, Hengelo (NL)

Correspondence Address: MARK W. SINCELL;Williams, Morgan & Amerson, P.C., 10333 Richmond, Suite 1100, Houston, TX, 77042, US

(21) Appl. No.: 11/618,089

(22) Filed: Dec. 29, 2006

(51) Int. Cl. H04L 12/66

(52) U.S. Cl. 370/401

(57) ABSTRACT

The present invention provides a method for interconnecting a plurality of local area networks that are each communicatively coupled to one of a plurality of provider edge nodes. The method includes forming a plurality of tunnels to communicatively connect each of the plurality of provider edge nodes with each of the other nodes in the plurality of provider edge nodes. The method also includes grouping provider nodes to form at least one first island and at least one second island. The first and second pluralities of provider nodes each include at least one of the provider edge nodes and at least one of the provider nodes is configured to function as a first island edge node. At least one inter-island tunnel is formed from the tunnels to communicatively connect each first island edge node with each second island edge node.

### 1. FIELD OF THE INVENTION

This invention relates generally to communications, and more particularly, to wireless communications.

### 2. DESCRIPTION OF THE RELATED ART

Many communication systems provide different types of services to users of processor-based devices, such as computers or laptops. In particular, data communication networks may enable such device users to exchange peer-to-peer and/or client-to-server messages, which may include multi-media content, such as data and/or video. For example, a user may access Internet via a Web browser over a Virtual Local Area Network (VLAN). A virtual LAN may comprise computers or servers located in different physical areas such that the same physical areas are not necessarily on the same LAN broadcast domain. By using switches, many individual workstations connected to switch ports (e.g., 10/100/1000 Mega bits per second (Mbps)) may create a broadcast domain for a VLAN. Examples of VLANs include port-based, Medium Access Control (MAC)-based, or IEEE standard based. While a port-based VLAN relates to a switch port on which an end device is connected, a MAC-based VLAN relates to a MAC address of an end device.

A Virtual Private Local Area Network (LAN) service (VPLS) is a provider service that emulates the full functionality of a traditional Local Area Network (LAN). A VPLS enables interconnection of many LANs over a network. In this way, even remote LANs may operate as a unified LAN. For enabling a VPLS, a virtual private LAN may be provided over a Multiprotocol Label Switching (MPLS) network. An MPLS network may integrate several geographically dispersed processing sites or elements, such as provider edge nodes (PEs), to share Ethernet connectivity for an MPLS-based application. An IETF standard specifies VPLS for Internet in an RFC specification. Virtual Private LAN Services (VPLSs) compliant with the IETF standard may provide multipoint Ethernet connectivity over an MPLS network.

A network providing VPLS services consists of Provider Edge Nodes (PE) and Provider Nodes (P). Each customer has a set of customer LANs that are connected to PE nodes, which will be interconnected to form the VPLS network to provide connectivity among the customer LANs. The provider creates a connection (e.g., a pseudo wire, PW) between every pair of PE nodes to which one of the customer LANS is attached. Customer LANs are connected to these PWs using the so-called Forwarder Function. The Forwarder Function forwards Ethernet Frames onto one of the connected PWs based on the Medium Access Control (MAC) destination address contained in the frame. Since there may be multiple customers connected to each PE node, there may be multiple such PW connections between pairs of PE nodes. These connections can be multiplexed into a tunnel interconnecting these PE nodes. These tunnels may start at the PE nodes, or at another node further into the network.

Both the tunnel and the PWs may be Label Switched Paths (LSPs). An LSP is a set of hops across a number of MPLS nodes that may transport data, such as IP packets, across an MPLS network. At the edge of the MPLS network, the incoming traffic may be encapsulated in a MPLS frame and routed. An MPLS network may obviate some of the limitations of Internet Protocol (IP) routing. For example, in IP routing, IP packets may be assigned to a Forwarding Equivalence Class (FEC) at the edge of a MPLS domain once, whereas the MPLS protocols may assign the FEC class at every hop in the LSP. The FEC, such as a destination IP subnet, refers to a set of IP packets that are forwarded over the same path and handled as the same traffic. The assigned FEC is encoded in a label and prepended to a packet. When the packet is forwarded to its next hop, the label is sent along with it, avoiding a repetitive analysis of a network layer header. The label may provide an index into a table which specifies the next hop and further provides a new label that may replace the label currently associated with the packet. By replacing the old label with the new label, the packet is further forwarded to its next hop, and this process may continue until the packet reaches an outer edge of the MPLS domain and normal IP forwarding is resumed. Labels may be flexible objects which can be communicated within network traffic. LSPs can be stacked so that one LSP is transported using another LSP. In this case forwarding is based on the label of the outer LSP until this label is popped from the stack. The mapping of PW into tunnels for VPLS is an example of LSP stacking.

Tunnels may be formed between each pair of provider edge nodes to interconnect a plurality of provider edge nodes. Thus, a VPLS network may include a large number of tunnels between provider edge nodes. For example, approximately N*(N−1) tunnels may be required to interconnect N provider edge nodes, which may potentially result in as many as N*(N−1) LSPs passing through nodes in the VPLS network. Each provider node maintains state information for each LSP associated with a tunnel that passes through the provider node. Depending on the VPLS network topology, each provider node in the network may be required to support a large fraction of the N*(N−1) LSPs. In contrast, each provider edge node only needs to support approximately N−1 tunnels. For networks that include large numbers of provider edge nodes, the number of tunnels scales in proportion to N², which makes large scale VPLS deployments difficult to implement.

One type of VPLS deployments that may be used to address the scalability problem is referred to as a hierarchical VPLS (H-VPLS). In an H-VPLS deployment, VPLS networks may be divided up into islands and the interconnection of these islands is inside the provider network. The H-VPLS deployment forwards frames based on an Ethernet MAC address between the VPLS islands. Consequently, scalability of the Ethernet MAC addresses is introduced. In a VPLS instance MAC addresses are learned by the provider edge nodes at the edge of the network. Between the edge nodes there are only P nodes that do not learn MAC addresses as a consequence inside the provider network there is no MAC learning, only at edge nodes. The number of MAC addresses learned by each provider edge node is related to the number of VPLS instances active on the provider edge node, i.e. on the number of LANs connected to the PE that need to be interconnected via a VPLS instance. This number is larger than the number of VPLS instances in edge nodes and thus the resources allocated for MAC learning are much larger. Furthermore, the number of the MAC addresses that must be learned by the provider edge nodes may grow to a potentially unlimited size as the number of LANs connected to each provider edge node increases. Not learning the MAC addresses leads to a wastage of bandwidth since frames may than be flooded, i.e., sent anywhere else rather than necessarily to a desired recipient.

### SUMMARY OF THE INVENTION

The present invention is directed to overcoming, or at least reducing, the effects of, one or more of the problems set forth above. The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

In one embodiment of the present invention, a method is provided for interconnecting a plurality of local area networks that are each communicatively coupled to one of a plurality of provider edge nodes. The method includes forming a plurality of tunnels to communicatively connect each of the plurality of provider edge nodes with each of the other nodes in the plurality of provider edge nodes. The method also includes grouping first and second pluralities of provider nodes to form at least one first island and at least one second island. The first and second pluralities of provider nodes each include at least one of the provider edge nodes and at least one of the provider nodes is configured to function as a first island edge node. At least one inter-island tunnel is formed from the tunnels to communicatively connect each first island edge node with each second island edge node.

### BRIEF DESCRIPTION OF THE DRAWINGS

The invention may be understood by reference to the following description taken in conjunction with the accompanying drawings, in which like reference numerals identify like elements, and in which:

FIG. 1 schematically depicts a first exemplary embodiment of a communication network including a plurality of provider nodes for enabling a service, according to one illustrative embodiment of the present invention;

FIG. 2 schematically depicts a second exemplary embodiment of a communication network including a plurality of provider nodes for enabling a service, according to one illustrative embodiment of the present invention;

FIG. 3 schematically depicts a third exemplary embodiment of a communication network including a plurality of provider nodes for enabling a service, according to one illustrative embodiment of the present invention;

FIG. 4 schematically depicts a fourth exemplary embodiment of a communication network including a plurality of provider nodes for enabling a service, according to one illustrative embodiment of the present invention;

FIG. 5 schematically depicts a fifth exemplary embodiment of a communication network including a plurality of provider nodes for enabling a service, according to one illustrative embodiment of the present invention;

FIG. 6 schematically depicts a first exemplary embodiment of a method of forming connections between islands including a plurality of provider edge nodes, according to one illustrative embodiment of the present invention; and

FIG. 7 schematically depicts a first exemplary embodiment of a method of forming connections between second-level islands including a plurality of islands, according to one illustrative embodiment of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions may be made to achieve the developers' specific goals, such as compliance with system-related and business-related constraints, which will vary from one implementation to another. Moreover, it should be appreciated that such a development effort might be complex and time-consuming, but may nevertheless be a routine undertaking for those of ordinary skill in the art having the benefit of this disclosure.

Generally, a method and an apparatus are provided for interconnecting a plurality of provider edge nodes in a network that includes the provider edge nodes and a plurality of provider nodes. Subsets of the plurality of provider edge nodes and the provider nodes are grouped into a first set of islands. Each island includes at least one island edge node that bounds the island. Tunnels may then be formed between all provider edge nodes in the network. A tunnel between two PEs that are located in different islands may then be multiplexed in the island edge node to form one or more higher level tunnels to one or more other island nodes. For example, PE nodes of a network providing Virtual Private Local Area Network (LAN) service (VPLS) may be grouped into multiple islands each containing multiple provider edge nodes. A core island may be formed to connect the multiple islands that are bounded by island edge nodes. The core island supports a mesh of inter-island tunnels between the island edge nodes of the multiple islands. Each island edge node maps tunnels that are destined for the same island into a common inter-island tunnel. As a consequence, the number of tunnels in the core island depends on the number of islands (M) instead of the number of provider edge nodes (N).

Scalability of the VPLS network may be improved by implementing islands connected by inter-island tunnels. The number of inter-island tunnels scales as M*(M−1) instead of the N*(N−1) scaling for a full mesh of provider edge tunnels, where M is the total number of islands in the network and N is the total number of PE nodes in the network. In each island, the number of tunnels is based on the number of provider edge nodes (PEs) that are located in the island (N/M on average) times the total number of provider edge nodes (PEs), so it scales with N/M*N, which is significantly less than N*(N−1), especially for large N. In some cases, the island edge nodes may be grouped again in a second level set of islands that are interconnected via a second level core. A multi-layer interconnection of islands via LSP may be recursively applied to further enhance the scalability of VPLS in a Multi-protocol Label Switching (MPLS) network.

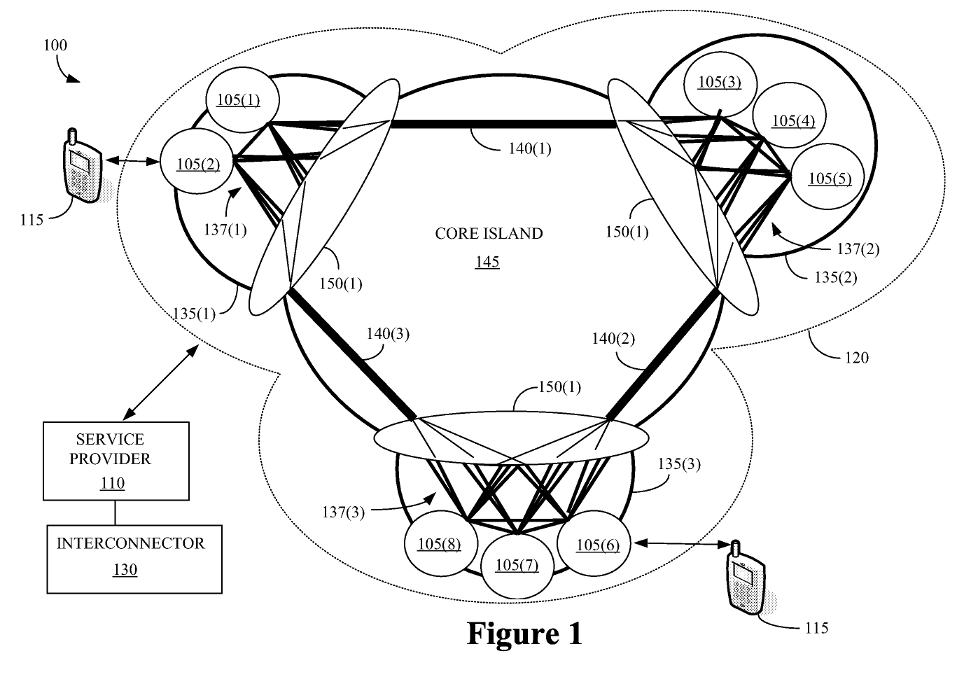

Referring to FIG. 1, a communication network 100 which enables interconnecting of a plurality of provider edge nodes (PEs) 105(1-n) is schematically depicted in accordance with one embodiment of the present invention. A service provider 110, such as a network operator of the communication network 100 may enable a service for a plurality of network-enabled devices 115 (only two shown) associated with customers. Examples of the services include, but are not limited to, Internet connectivity services, such as a virtual private network Local Area Network (LAN) services (VPLSs). The communication network 100 may include a frame relay network 120 that enables the service provider 110 to provide a VPLS service to the customers. In particular, the frame relay network 120 may comprise an MPLS network that may be used to communicate frames 125 associated with the plurality of network-enabled devices 115.

Persons of ordinary skill in the art should appreciate that portions of the communication network 100, the frame relay network 120 of the provider edge nodes 105 and the service provider 110 may be suitably implemented in any number of ways to include other components using hardware, software or a combination thereof. Communication network, protocol clients, servers are known to persons of ordinary skill in the art and so, in the interest of clarity, only those aspects of the data communications network that are relevant to the present invention will be described herein. In other words, unnecessary details not needed for a proper understanding of the present invention are omitted to avoid obscuring the present invention. Services provided by the communication network 100 may include Internet connectivity, multi-point Ethernet connectivity, a virtual private Local Area Network service (VPLS), and the like.

The service provider 110 may comprise an interconnector 130 for enabling interconnection of the plurality of provider edge nodes 105(1-8). The indices (1-8) may be used to indicate individual provider edge nodes 105(1-8) and/or subsets thereof. However, the indices may be dropped when the provider edge nodes 105 are referred to collectively. This convention may be applied to other elements shown in the drawings and indicated by a numeral and one or more distinguishing indices. The interconnector 130 may cause the plurality of provider edge nodes 105 to form direct connections or tunnels 137 between sets of provider nodes among the plurality of provider edge nodes 105. For example, the interconnector 130 may group the plurality of provider edge nodes 105 into a first, a second, and a third island 135. The interconnector 130 may also cause connections, which may be referred to an inter-island tunnels 140, to be formed between the first, second, and third islands 135(1-k) in a single island, such as a core island 145. The inter-island tunnels 140 comprise or encapsulate the tunnels 137 between the provider edge nodes 105 associated with the islands 135 connected by each inter-island tunnel 140. In one embodiment, the tunnels 137 and/or the inter-island tunnels 135 may be implemented as label switched paths (LSPs).

The inter-island tunnels 140 may be used to communicatively connect provider nodes associated with each of the islands 135. In one embodiment, each of the islands 135 designates a node to function as an island edge node 150. One of the provider edge nodes 105 may function as an island edge node 150, but the present invention is not limited to this case. In alternative embodiments, other provider nodes within the islands 135 may be designated as the island edge node 150 for the island 135. For example, the first island 135(1) designates a first island edge node 150(1), which may form the inter-island tunnel 140(1) by combining or multiplexing direct connections or tunnels 137 that connect provider edge nodes 105(1-2) in the first island 135(1) to provider edge nodes 105(3-5) in the second island 135(2). For forming the common connection or inter-island tunnel 140(1) between the sets of provider nodes, the interconnector 130 may determine the sets of provider nodes from the plurality of provider edge nodes 105(1-n), identifying each pair of the plurality of provider nodes (1-n) with a direct connection or tunnel 137.

In operation, the interconnector 130 may cause an island 135 to multiplex a set of connections between the sets of provider edge nodes 105 that connect one island 135 to another island 135, e.g., the first island 135(1) to the second island 135(2) into a common connection 140(1) that interconnects the first and second islands 135(1, 2). By using the common connection 140(1) between the first and second islands 135(1, 2), the frame relay network 120 may enable a virtual private local area network (LAN) service (VPLS) in some embodiments of the present invention. Each provider edge node 105 may comprise a node interconnector (not shown) to form a direct connection with other provider nodes of the plurality of provider edge nodes 105. Likewise, each island 135 may determine a particular provider node that may operate as an island edge node 150 that may map a set of connections between two islands 135 into a single connection. In one alternative embodiment, which will be discussed in more detail below, interconnector 130 may form a multi-layer configuration from the plurality of provider edge nodes 105 and island edge nodes 150.

Grouping the provider edge nodes 105 into islands 135 and then providing inter-island tunnels 140 between the islands 135 may reduce the total number of tunnels that must be supported by a single node within the frame network 120. For example, if the frame network 120 includes “N” provider edge nodes 105, then approximately N*(N−1) tunnels may be formed between provider edge nodes 105 in the frame relay network 120 of the communication network 100. As discussed herein, the “N” provider edge nodes 105 may be grouped into “M” islands 135, so that the frame relay network 120 splits the “N” number of provider edge nodes 105 into N/M nodes per island 105. This grouping of the “N” number of provider edge nodes 105 may result in (N/M)*N LSP tunnels per island 135. Each provider edge node 105 may map the Island/Core edge (N/M)*N island tunnels 137 in M interconnect tunnels 140. The M islands 135 result in M*M interconnect tunnels 140 in the core island 145. As a result, the communication network 100 may interconnect the “N” number of provider edge nodes 105 using at most M*M LSPs through the nodes (not shown) in the core island 145 of the frame relay network 120 and at most (N/M)*N LSPs through the nodes (not shown) in the islands 135 of the frame relay network 120.

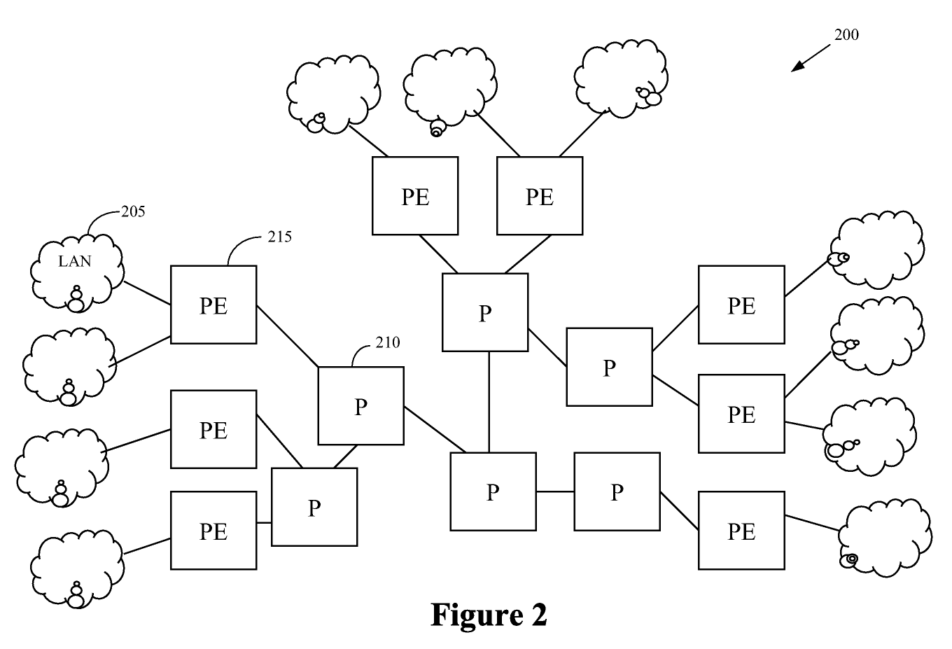

FIG. 2 schematically depicts a second exemplary embodiment of a communication network 200. In the illustrated embodiment, the communication network 200 includes a plurality of local area networks (LAN 205, only one indicated by a numeral in FIG. 2). Each local area network 205 may include one or more network-enabled devices (not shown) that may be interconnected by any number of wired and/or wireless connections. Furthermore, persons of ordinary skill in the art should appreciate that each local area network 205 may include various servers, routers, access points, base stations, and the like. However, the actual makeup of each local area network 205 is a matter of design choice and not material to the present invention.

The communication network 200 also includes a plurality of provider nodes (P) 210. In the interest of clarity only one provider node is indicated by the numeral 210. The provider nodes 210 may be implemented in any combination of hardware, firmware, and/or software. For example, the provider nodes 210 may be implemented in a server that comprises at least one processor and memory for storing and executing software or firmware that may be used to implement the techniques described herein as well as other operations known to persons of ordinary skill in the art. One or more of the provider nodes 210 may be designated as provider edge nodes (PE) 215, only one indicated by a numeral in FIG. 2. Provider edge nodes 215 may be substantially similar to provider nodes 210 except that the provider edge nodes 215 are configured to act as an entry node for one or more local area networks 205. In one embodiment, a single entity may act as both a provider node 210 and a provider edge node 215. Techniques for designating and/or operating provider nodes 210 and/or provider edge nodes 215 are known to persons of ordinary skill in the art and in the interest of clarity only those aspects of operating the provider nodes 210 and/or provider edge nodes 215 that are relevant to the present invention will be described herein.

The provider edge nodes 215 and provider nodes 210 may be interconnected by various physical (wired and/or wireless) connections between the nodes 210, 215. Persons of ordinary skill in the art having benefit of the present disclosure should appreciate that the specific physical interconnections are typically determined by the topology of the communication network 200 and are not material to the present invention. When the local area networks 205 and the communication network 200 are configured to operate as a virtual local area network, tunnels are defined between each of the local area networks 205, as discussed in detail elsewhere herein. Each tunnel consists of a path from one local area network 205 through a first provider edge node 215 that is communicatively coupled to the first local area network 205, possibly through one or more provider nodes 210, and through a second provider edge node 215 that is communicatively coupled to the second local area network 205. Each step to or from a local area network 205 to or from a provider edge node 210 and from each provider node 215 to another node 210, 215 may be referred to as a “hop.” Thus, each tunnel or path includes a selected set of hops through the network 200.

Each provider node 210 and provider edge node 215 may maintain state information for the hops that pass through the node 210, 215. In one embodiment, the state information includes information identifying the particular tunnel and information indicating the next node 210, 215 or local area network 205 in the tunnel. Thus, packets traveling in a tunnel may be forwarded to the correct next node 210, 215 or local area network 205 in the tunnel when they are received at the nodes 210, 215 of the tunnel. However, maintaining state information at every node 210, 215 for all of the PE-PE tunnels that may be supported by the network 200 may consume a large amount of the resources available to the nodes 210, 215. Moreover, the resources at each node 210, 215 required to support the tunnels and store the state information may, as discussed above, scale in proportion to the square of the total number of PE nodes 215 that are included in the network to provide VPLS services. Increasing the number of PE nodes 215 may therefore place an inordinate burden on the nodes 210, 215 and, in some cases, this may place an upper limit on the number of nodes 210, 215 that may be used to provide VPLS services. The nodes 210, 215 may therefore be grouped into islands.

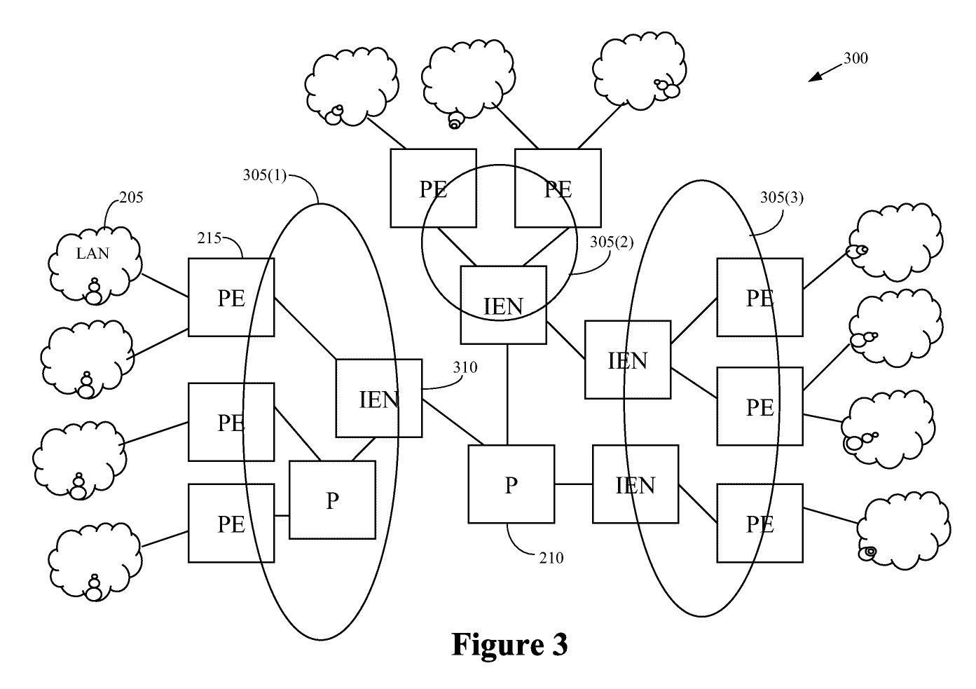

FIG. 3 schematically depicts a third exemplary embodiment of a communication network 300. In the illustrated embodiment, groups of nodes 210, 215 may be combined into islands 305 and one or more of the nodes 210, 215 may be designated as a island edge node (IEN) 310. In the interest of clarity, only one island edge node 310 is indicated by a numeral. The island edge nodes 310 may include an existing provider node 210 or provider edge node 215, or they may be formed using a different node. The island edge nodes 310 are configured to support inter-island tunnels between the islands 305. In one embodiment, the island edge nodes 310 may multiplex PE-PE tunnels to form the inter-island tunnels. For example, the PE-PE tunnels that support the LAN-LAN tunnels that connect the LANs 205 that are coupled to the island edge node 305(1) to the LANs 205 that are coupled to the island edge node 305(2) may be multiplexed to form an inter-island tunnel between the islands 305(1-2). Similarly, the PE-PE tunnels that support the LAN-LAN tunnels that connect the LANs 205 that are coupled to the island edge node 305(2) to the LANs 205 that are coupled to the island edge node 305(3) may be multiplexed to form an inter-island tunnel between the islands 305(2-3). Nodes 210, 215 that lie along the inter-island tunnel may therefore only have to support and/or store state information for inter-island tunnels, which may significantly reduce the resource demands on these nodes. Moreover, as discussed above, the resource demands on these nodes 210, 215 no longer scale in proportion to the square of the total number of PE nodes 215 that are included in the network to support VPLS services, which may improve scalability of the network in supporting VPLS services.

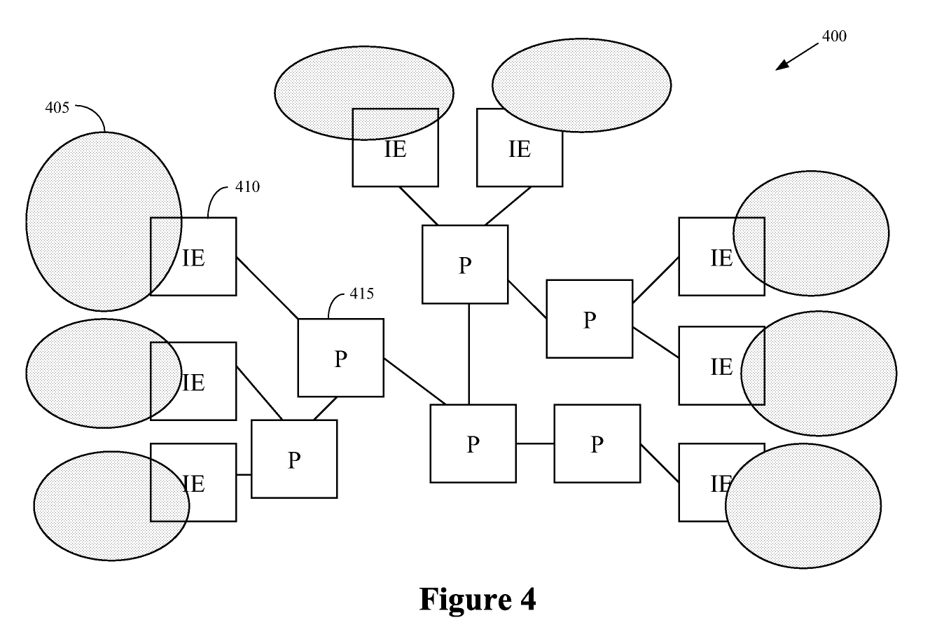

FIG. 4 schematically depicts a fourth exemplary embodiment of a communication network 400. The fourth exemplary embodiment depicts an alternate view of the topology of a communication network, such as the communication network 300 shown in FIG. 3, after grouping nodes 210, 215 into islands 405 that include one or more island edge (IE) nodes 410. The fourth exemplary embodiment also differs from the third exemplary embodiment in that the communication network 400 includes more provider nodes 415 between the island edge nodes 410. If the number of islands 405 grows large enough, a virtual local area network formed using the communication network 400 may include a number of inter-island tunnels that scales in proportion to the square of the number of islands 405. Thus, the resources of each provider node 415 that are required to support the inter-island tunnels may grow prohibitively large. The islands 405 and provider nodes 415 may therefore be grouped into other islands to form a multi-level island structure.

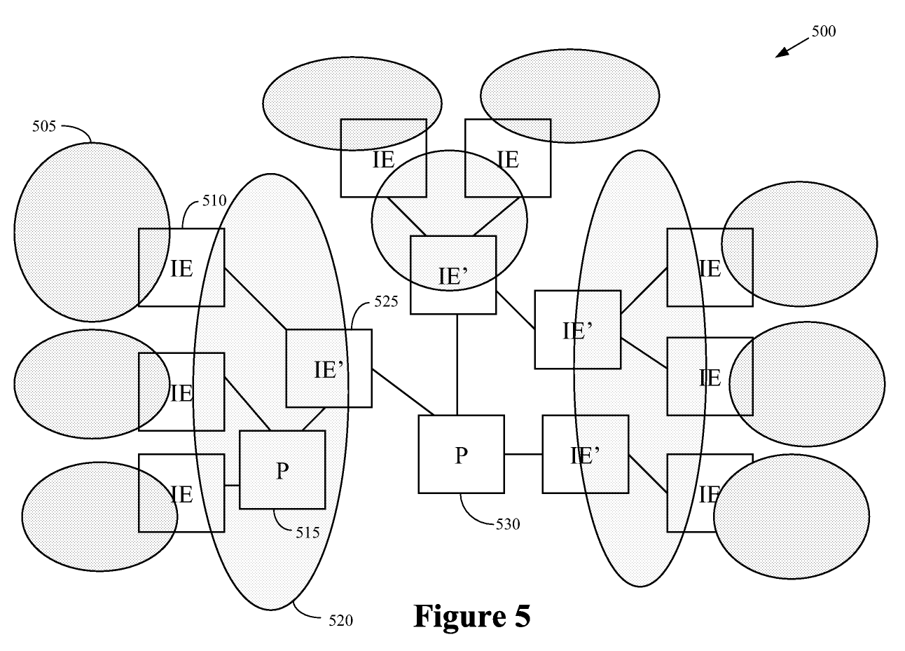

FIG. 5 schematically depicts a fifth exemplary embodiment of a communication network 500. In the fifth exemplary embodiment, the islands 505 (which may be referred to as first-level islands 505), their associated island edge nodes 510 and one or more provider nodes 515 are grouped into second-level islands 520. Each of the second-level islands 520 includes at least one second-level island edge node (IE′) 525. The second-level island edge nodes 525 may multiplex first level inter-island tunnels (such as the tunnels connecting the island edge nodes 410 in FIG. 4) to form second-level inter-island tunnels. Nodes 530 that lie along the second level inter-island tunnel may therefore only have to support and/or store state information for the second level inter-island tunnels, which may significantly reduce the resource demands on these nodes, and the resource demands on these nodes 530 may no longer scale in proportion to the square of the total number of first-level islands 505, which may improve scalability of the network for providing VPLS services. In one embodiment, the first level tunnels may be recursively aggregated to form the second level tunnels. Additional levels of islands may be added when the number of islands in the current level becomes sufficiently large.

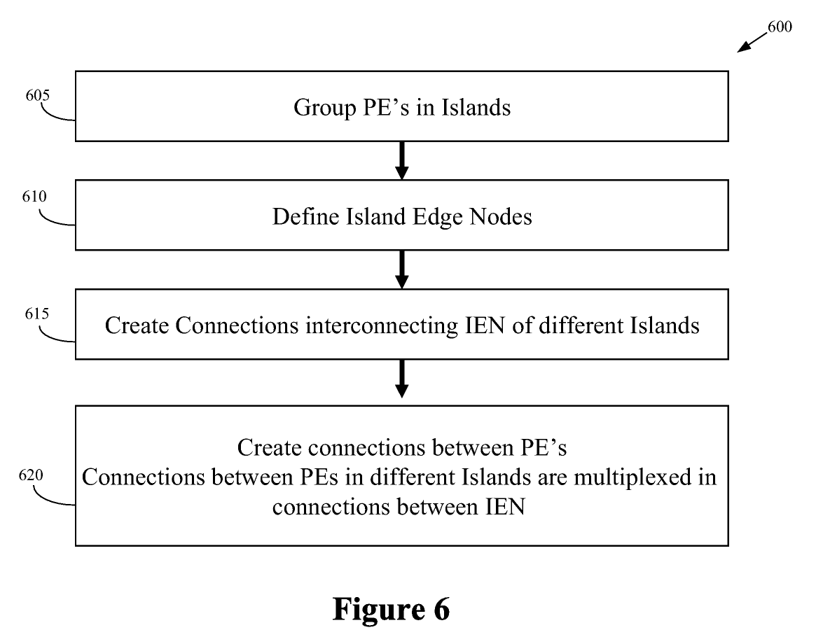

FIG. 6 schematically depicts a first exemplary embodiment of a method 600 of forming connections between islands including a plurality of provider edge nodes. In the illustrated embodiment, provider nodes including provider edge nodes (PE) that are coupled to local area networks are grouped (at 605) into islands. One or more island edge nodes (IEN) are then defined (at 610) for each of the islands and connections are formed to interconnect the island edge nodes of different islands. Each of the provider edge nodes may then be connected (at 620) and the connections between the provider edge nodes in different islands may be multiplexed (at 620) into the connections between the island edge nodes to form tunnels between the island edge nodes. This technique may be referred to as recursively aggregating the connections between the provider edge nodes into the inter-island tunnels.

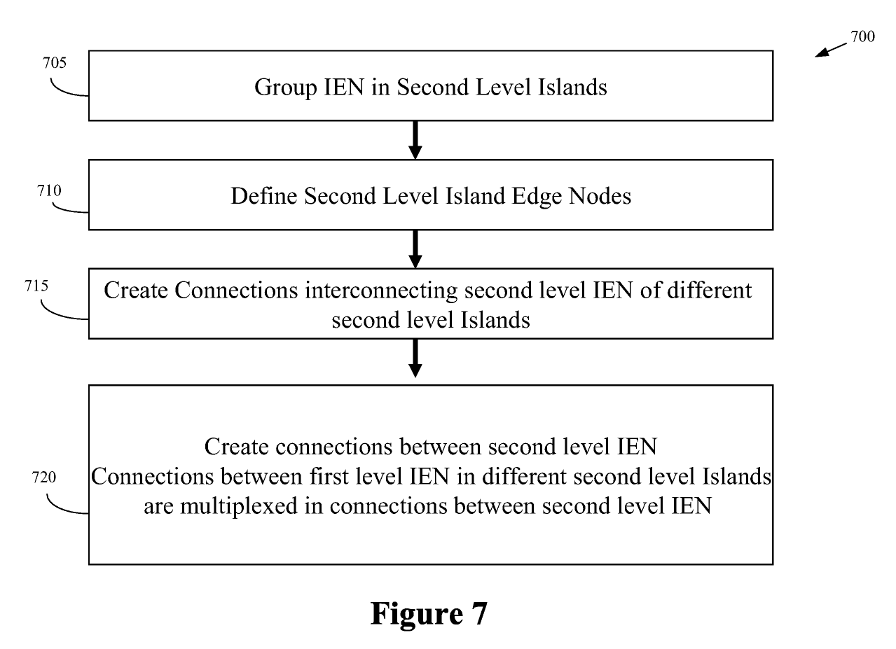

FIG. 7 schematically depicts a first exemplary embodiment of a method 700 of forming connections between second-level islands including a plurality of islands. In the illustrated embodiment, island edge nodes (IEN), and in some cases provider nodes, associated with first-level islands may be grouped (at 705) into second-level islands, as discussed in detail above. One or more second-level island edge nodes are then defined (at 710) for each of the second-level islands and connections are formed to interconnect the second-level island edge nodes of different second-level islands. Each of the first-level island edge nodes may then be connected (at 720) and the connections between the first-level island edge nodes in different second-level islands may be multiplexed (at 720) into the connections between the second-level island edge nodes to form tunnels between the second level island edge nodes. This technique may be referred to as recursively aggregating the connections between the first-level island edge nodes into the second-level inter-island tunnels. Persons of ordinary skill in the art having benefit of the present disclosure should appreciate that the recursive technique described herein may be applied to form any number of levels of islands and corresponding inter-island tunnels.

Portions of the present invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

The present invention set forth above is described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

While the invention has been illustrated herein as being useful in a communications network environment, it also has application in other connected environments. For example, two or more of the devices described above may be coupled together via device-to-device connections, such as by hard cabling, radio frequency signals (e.g., 802.11(a), 802.11(b), 802.11(g), Bluetooth, or the like), infrared coupling, telephone lines and modems, or the like. The present invention may have application in any environment where two or more users are interconnected and capable of communicating with one another.

Those skilled in the art will appreciate that the various system layers, routines, or modules illustrated in the various embodiments herein may be executable control units. The control units may include a microprocessor, a microcontroller, a digital signal processor, a processor card (including one or more microprocessors or controllers), or other control or computing devices as well as executable instructions contained within one or more storage devices. The storage devices may include one or more machine-readable storage media for storing data and instructions. The storage media may include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy, removable disks; other magnetic media including tape; and optical media such as compact disks (CDs) or digital video disks (DVDs). Instructions that make up the various software layers, routines, or modules in the various systems may be stored in respective storage devices. The instructions, when executed by a respective control unit, causes the corresponding system to perform programmed acts.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

We claim:

1. A method of interconnecting a plurality of local area networks that are each communicatively coupled to one of a plurality of provider edge nodes, the method comprising:
forming a plurality of tunnels to communicatively connect each of the plurality of provider edge nodes with each of the other nodes in the plurality of provider edge nodes;
grouping at least one first plurality of provider nodes to form at least one first island, the first plurality of provider nodes comprising at least one of said plurality of provider edge nodes and at least one of the plurality of provider nodes being configured to function as a first island edge node;
grouping at least one second plurality of provider nodes to form at least one second island, the second plurality of provider nodes comprising at least one of said plurality of provider edge nodes and at least one of the plurality of provider nodes configured to function as a second island edge node, the second plurality of provider nodes differing from the first plurality of provider nodes;
forming at least one inter-island tunnel to communicatively connect each first island edge node with each second island edge node, said at least one inter-island tunnel comprising tunnels that communicatively connect provider edge nodes associated with the first and second islands.

2. A method, as set forth in claim 1, further comprising:
enabling said plurality of local area networks to function as a virtual private local area network over said tunnels and inter-island tunnels.

3. A method, as set forth in claim 1, wherein grouping the first and second pluralities of provider nodes further comprises:
interconnecting each pair of said plurality of provider nodes with a direct connection therebetween to create said first and second islands from said plurality of provider nodes.

4. A method, as set forth in claim 1, wherein forming said at least one inter-island tunnel comprises multiplexing the tunnels that communicatively connect provider edge nodes associated with the first and second islands, said multiplexing occurring at said island edge nodes.

5. A method, as set forth in claim 4, wherein forming said at least one inter-island tunnel comprises mapping the plurality of tunnels that communicatively connect each of the plurality of provider edge nodes into said at least one inter-island tunnel.

6. A method, as set forth in claim 5, wherein forming said at least one inter-island tunnel comprises forming said at least one inter-island tunnel as a label switched path.

7. A method, as set forth in claim 6, wherein said at least one first island and at least one second island form a plurality of first level islands, the method further comprising:
grouping pluralities of first-level islands to form a plurality of second-level islands, each second level island comprising a provider node that functions as a second-level island edge node; and
forming at least one second-level inter-island tunnel to communicatively connect each second-level island edge node with each of the other second-level island edge nodes, said at least one second-level inter-island tunnel comprising inter-island tunnels that communicatively connect island edge nodes associated with the first and second islands.

8. A method, as set forth in claim 7, wherein forming said at least one second-level inter-island tunnel comprises:
recursively providing said second-level island edge nodes; and
multiplexing, at the second-level island edge nodes, the inter-island tunnels that communicatively connect island edge nodes associated with the first and second islands.

9. A method, as set forth in claim 1, wherein said plurality of provider edge nodes are communicatively coupled to a plurality of network-enabled devices for customers associated with at least one of the plurality of local area networks.

10. A method, as set forth in claim 9, wherein further comprising:
configuring the tunnels to transfer frames between said plurality of network-enabled devices.

11. A method, as set forth in claim 9, further comprising:
providing one or more Internet connectivity services to said customers based over said at least one inter-island tunnel.

12. A method, as set forth in claim 11, further comprising:
enabling a multi-point Ethernet connectivity for said plurality of local area networks.

13. A method, as set forth in claim 12, wherein enabling multi-point Ethernet connectivity further comprises:
providing said multi-point Ethernet connectivity over an MPLS network.

14. A method, as set forth in claim 13, further comprising:
enabling a virtual private local area network service over said MPLS network.

15. A method, as set forth in claim 18, wherein said inter-island tunnel comprises a mesh of tunnels between said first and second islands.

16. A method, as set forth in claim 15, further comprising:
providing scalability of said virtual private local area network service based on said tunnels and inter-island tunnels.
